(19) United States
(12) Patent Application Publication
(10) Pub. No.: US 2025/0051242 A1
(43) Pub. Date: Feb. 13, 2025

(54) CONTAINER COATED WITH A MGAL2O4 SPINEL AND CORUNDUM COATING

(71) Applicant: SAINT-GOBAIN CENTRE DE RECHERCHES ET D'ETUDES EUROPEEN, COURBEVOIE (FR)

(72) Inventors: Jérôme BRULIN, CAVAILLON CEDEX (FR); Costana Mihaela IONICA BOUSQUET, CAVAILLON CEDEX (FR); Xavier COEURET, CAVAILLON CEDEX (FR); Adrien VINCENT, CAVAILLON CEDEX (FR)

(21) Appl. No.: 18/721,588

(22) PCT Filed: Dec. 23, 2022
(86) PCT No.: PCT/FR2022/052494

§ 371 Date: Jun. 18, 2024

(30) Foreign Application Priority Data
Dec. 23, 2021 (FR) FR2114402

(51) Int. Cl. C04B 41/50; C04B 35/119; C04B 41/00; C04B 41/45; C04B 41/87

(52) U.S. Cl. CPC C04B 41/5031; C04B 35/119; C04B 41/009; C04B 41/4543; C04B 41/87; C04B 2235/3222; C04B 2235/3225; C04B 2235/3244; C04B 2235/3418; C04B 2235/763; C04B 2235/9669

(57) ABSTRACT

A container for manufacturing an oxide powder including lithium, the surface of the inner walls of which is at least partially covered with a coating having the following crystalline phases, as a percentage based on the total weight of the crystalline phases: MgAl₂O₄ spinel: more than 25% and up to 60%, and crystalline phases other than MgAl₂O₄ spinel and corundum: <10%, and corundum: supplemented to 100%.

### TECHNICAL FIELD

The present invention relates to a container, the surface of the inner walls thereof being at least partially covered, preferably by more than 80%, with a coating and the use of said container to manufacture an oxide powder comprising lithium, in particular an oxide of a metal or of several lithiated transition metals.

### PRIOR ART

Lithium-ion battery requirements are constantly increasing. Many of them comprise a part, generally the cathode, made of an oxide comprising lithium, notably an oxide of a metal or of several lithiated transition metals, in particular LiFePO₄ (or LPF), LiMn₂O₄ (or LMO), or a lithium-nickel-manganese-cobalt (or Li—NMC) oxide.

The cathode is generally manufactured by grinding said oxide of a metal or of several lithiated transition metals into powder form.

Conventional methods for manufacturing said powders include the production of a mixture of oxides and/or different oxide precursors, followed by heat treatment to carry out solid-phase synthesis of the oxide of a metal or of several lithiated transition metals. During said heat treatment, the mixture is placed in a container, generally called a “sagger”. The conditions for synthesizing said powders, as well as said mixture, in particular the elements containing lithium, place the container under particular stress.

There is a need to increase the service life of said containers.

One aim of the invention is to at least partially meet this need.

### OVERVIEW OF THE INVENTION

According to the invention, this aim is achieved by means of a container, the surface of the inner walls of said container being partially covered, preferably more than 80%, and preferably over the entirety of said inner walls, with a coating having the following crystallized phases, as a percentage by weight based on the total weight of the crystalline phases:
MgAl₂O₄ spinel: greater than 25% and up to 60%, and
Crystalline phases other than MgAl₂O₄ spinel and corundum: <10%, and
Corundum: supplemented to 100%.

The inventors have discovered that the coated container according to the invention exhibited lower degradation during its use, which allows for a longer service life, and in particular a greater number of cycles for manufacturing oxide powder of a metal or of several lithiated transition metals.

According to preferred but non-limiting embodiments of the present invention, which may, if appropriate, be combined with one another:
the coating has, as a percentage by weight based on the crystalline phases, a spinel content greater than 30%, preferably greater than 35% and/or less than 55%, preferably less than 50%;
the container comprises more than 90%, preferably more than 95%, preferably more than 99%, by weight, of oxide(s), carbide(s), nitride(s), oxynitride(s), boride(s), and mixtures thereof;
the coating has a thickness greater than 50 μm, preferably greater than 100 μm, preferably greater than 200 μm, preferably greater than 300 μm and less than 2000 μm, preferably less than 1500 μm, preferably less than 1000 μm, preferably less than 800 μm;
the surface of the covered inner walls comprises the bottom of said container and the part of the sides in contact with said bottom;
the surface of the inner walls is covered more than 85%, preferably more than 90%, preferably more than 95%;
the coating extends substantially over the entire surface of the inner walls of said container;
the container comprises more than 90%, preferably more than 95% by weight of oxide(s),
the container comprises Al₂O₃, MgO, ZrO₂, SiO₂, Y₂O₃ and mixtures thereof;
the container has a content of Al₂O₃+MgO+ZrO₂+SiO₂+Y₂O₃ greater than 90%, preferably greater than 95%, as an oxide weight percentage;
the container has a content of Al₂O₃ greater than 90%, preferably greater than 95%, as an oxide weight percentage;
the container has a content of SiO₂ greater than 90%, preferably greater than 95%, as an oxide weight percentage;
the container has a content of Al₂O₃+MgO greater than 90%, preferably greater than 95%, as an oxide weight percentage;
the container has a content of Al₂O₃+Y₂O₃ greater than 90%, preferably greater than 95%, as an oxide weight percentage;
the container has a content of Al₂O₃+MgO+SiO₂ greater than 90%, preferably greater than 95%, as an oxide weight percentage;
the container has a content of Al₂O₃+ZrO₂+SiO₂ greater than 90%, preferably greater than 95%, as an oxide weight percentage;
the container has a content of Al₂O₃+ZrO₂ greater than 90%, preferably greater than 95%, as an oxide weight percentage;
the container has a content of Al₂O₃+SiO₂ greater than 90%, preferably greater than 95%, as an oxide weight percentage;
the container comprises more than 90%, preferably more than 95%, as a weight percentage based on the weight of the crystalline phases of corundum, MgAl₂O₄ spinel, cordierite, mullite, zirconia, optionally stabilized, periclase, and mixtures thereof;
the container comprises more than 90%, preferably more than 95%, as a percentage by weight, in total and based on the weight of the crystalline phases of corundum or mullite or a mixture of corundum and cordierite or a mixture of corundum and mullite or a mixture of corundum and MgAl₂O₄ spinel or a mixture of corundum and cordierite and spinel, or a mixture of corundum and zirconia or a mixture of corundum and mullite and zirconia or a mixture of cordierite and mullite;
the container comprises more than 90%, preferably more than 95% by weight, of carbide(s), nitride(s), oxynitride(s), borides and mixtures thereof;
the container comprises more than 90%, preferably more than 95% by weight, of preferably carbide(s), nitride(s), SiAlON and mixtures thereof;
the container comprises more than 90%, preferably more than 95% by weight, of silicon carbide, silicon nitride, SiAlON, and mixtures thereof;
the container comprises more than 90%, preferably more than 95% by weight, of a mixture of silicon carbide and silicon nitride;
the container has a perimeter chosen from a polygon, a circle or an ellipse;
the container comprises a bottom and at least one side, preferably having an average thickness of less than 20 mm and greater than 2 mm;
the container has a volume greater than 0.1 liters and less than 25 liters.

The invention also relates to the use of a coated container according to the invention to manufacture an oxide powder comprising lithium, in particular an oxide of a metal or of several lithiated transition metals.

### Definitions

“Ceramic” is understood to mean a product which is neither metallic nor organic. In the context of the present invention, carbon is considered to be a ceramic product.
“Coating” is understood to mean a layer of material(s) of a different nature to the surface of the container.
The “precursor” of a crystallized oxide is understood to mean one or more materials, which will result, after heat treatment at a temperature above 1100° C., preferably in air, in said crystallized oxide. For example, a corundum precursor may be a transition alumina or a boehmite or aluminum trihydroxide.
For the sake of clarity, the chemical formula of the simple oxides are used to designate the contents of these oxides in a composition. For example, “MgO” or “Al₂O₃” refers to the content of these simple oxides in the composition under consideration, whereas “magnesia” and “alumina” are used to denote the effective presence of the phases of these constituent oxides of MgO and Al₂O₃, respectively.
“Corundum” is conventionally understood to mean an alumina in rhombohedral crystal form.
A “sialon”, or SiAlON, is an oxynitride compound of at least the elements Si, Al and N, in particular a compound complying with one of the following formulas:
SiₓAl_{y}OᵤNᵥ, wherein:
x is greater than or equal to 0, greater than 0.05, greater than 0.1 or greater than 0.2, and less than or equal to 1, less than or equal to 0.8 or less than or equal to 0.4,
y is greater than or equal to 0, or greater than 0.1, greater than 0.3 or greater than 0.5, and less than or equal to 1,
u is greater than 0, greater than 0.1 or greater than 0.2, and less than or equal to 1 or less than or equal to 0.7,
v is greater than 0, greater than 0.1, greater than 0.2 or greater than 0.5, or greater than 0.7, and less than or equal to 1,
x+y>0,
   x, y, u and v being stoichiometric indices and normalized relative to the highest value, which is set to 1;
MeₓSi₁₂₋₍ₘ₊ₙ₎Al₍ₘ₊ₙ₎OₙN₁₆₋ₙ, with 0≤x≤2, Me a cation selected from lanthanide, Fe, Y, Ca, Li cations and mixtures thereof, 0≤m≤12, 0≤n≤12 and 0<n+m≤12, generally called “α′-SiAlON” or “SiAlON-α′”
Unless otherwise mentioned, all the oxide contents are oxide weight percentages. A weight content of an oxide of a metal element relates to the total content of this element expressed in the form of the most stable oxide, according to usual industry conventions.
The sum of oxide contents does not imply the presence of all of these oxides.
“comprise” or “include” should be interpreted without limitation, in the sense that other elements than those indicated may be present.

### DETAILED DESCRIPTION

### Container

The container is preferably ceramic.

Preferably, the container comprises more than 90%, preferably more than 95%, preferably more than 99%, preferably more than 99.5% by weight of oxide(s), carbide(s), nitride(s), oxynitride(s), boride(s) and mixtures thereof.

The container preferably comprises more than 90%, preferably more than 95%, preferably more than 99%, preferably more than 99.5%, by weight:
of oxide(s), or
of carbide(s), nitride(s), oxynitride(s), borides and mixtures thereof, preferably carbide(s), nitride(s), oxynitride(s) and mixtures thereof, preferably carbide(s), nitride(s), SiAlON and mixtures thereof, preferably carbide(s), nitride(s) and mixtures thereof, preferably silicon carbide, silicon nitride and mixtures thereof.

In a first embodiment, the container comprises more than 90%, preferably more than 95%, preferably more than 99%, preferably more than 99.5%, by weight of oxide(s).

Preferably, said oxide(s) are selected from or comprise Al₂O₃, MgO, ZrO₂, SiO₂, Y₂O₃, and mixtures thereof.

The container preferably has an Al₂O₃+MgO+ZrO₂+SiO₂+Y₂O₃ content greater than 90%, preferably greater than 95%, preferably greater than 98%, as an oxide weight percentage.

The container preferably has an Al₂O₃+MgO+ZrO₂+SiO₂ content greater than 90%, preferably greater than 95%, preferably greater than 98%, as an oxide weight percentage.

More preferably, the container has an Al₂O₃+MgO+SiO₂ content greater than 90%, preferably greater than 95%, preferably greater than 98%, as an oxide weight percentage.

In one embodiment of said first embodiment, the container has an Al₂O₃ content greater than 90%, preferably greater than 95%, preferably greater than 98%, preferably greater than 99%, as an oxide weight percentage.

In one embodiment of said first embodiment, the container has an SiO₂ content greater than 90%, preferably greater than 95%, preferably greater than 98%, preferably greater than 99%, as an oxide weight percentage.

In one embodiment of said first embodiment, the container has an Al₂O₃+MgO content greater than 90%, preferably greater than 95%, preferably greater than 98%, preferably greater than 99%, as an oxide weight percentage.

In one embodiment of said first embodiment, the container has an Al₂O₃+Y₂O₃ content greater than 90%, preferably greater than 95%, preferably greater than 98%, preferably greater than 99%, as an oxide weight percentage.

In one embodiment of said first embodiment, the container has an Al₂O₃+MgO+SiO₂ content greater than 90%, preferably greater than 95%, preferably greater than 98%, preferably greater than 99%, as an oxide weight percentage.

In one embodiment of said first embodiment, the container has an Al₂O₃+ZrO₂+SiO₂ content greater than 90%, preferably greater than 95%, preferably greater than 98%, preferably greater than 99%, as an oxide weight percentage.

In one embodiment of said first embodiment, the container has an Al₂O₃+ZrO₂ content greater than 90%, preferably greater than 95%, preferably greater than 98%, preferably greater than 99%, as an oxide weight percentage.

In one embodiment of said first embodiment, the container has an Al₂O₃+SiO₂ content greater than 90%, preferably greater than 95%, preferably greater than 98%, preferably greater than 99%, as an oxide weight percentage.

Preferably, the container comprises more than 90%, preferably more than 95%, in total, as a weight percentage based on the weight of the crystalline phases, of corundum, MgAl₂O₄ spinel, cordierite, mullite, zirconia, optionally stabilized, periclase, and mixtures thereof. More preferably, the container comprises more than 90%, preferably more than 95%, preferably more than 99%, preferably more than 99.5%, in total, as a weight percentage based on the weight of the crystalline phases, of corundum, MgAl₂O₄ spinel, cordierite, mullite, zirconia, optionally stabilized, and mixtures thereof.

Preferably, the container comprises more than 90%, preferably more than 95%, as a weight percentage based on the weight of the crystalline phases, of corundum or mullite or a mixture of corundum and cordierite or a mixture of corundum and mullite or a mixture of corundum and MgAl₂O₄ spinel or a mixture of corundum and cordierite and spinel, or a mixture of corundum and zirconia or a mixture of corundum and mullite and zirconia or a mixture of cordierite and mullite.

In a second embodiment, the container comprises more than 90%, preferably more than 95%, preferably more than 99%, preferably more than 99.5%, of carbide(s), nitride(s), oxynitride(s), borides and mixtures thereof, preferably of carbide(s), nitride(s), oxynitride(s) and mixtures thereof, preferably of carbide(s), nitride(s), SiAlON and mixtures thereof.

The container preferably comprises more than 90%, preferably more than 95%, preferably more than 98%, preferably more than 99% by weight of silicon carbide, silicon nitride, SiAlON and mixtures thereof.

In one embodiment of said second embodiment, the container comprises more than 90% of silicon carbide and the supplement comprises silicon metal.

More preferably, the container comprises more than 90%, preferably more than 95%, preferably more than 98%, preferably more than 99% by weight of silicon carbide, silicon nitride and mixtures thereof.

In one embodiment of said second embodiment, the container comprises more than 90%, preferably more than 95%, preferably more than 98%, preferably more than 99%, by weight, of silicon carbide.

In one embodiment of said second embodiment, the container comprises more than 90%, preferably more than 95%, preferably more than 98%, preferably more than 99%, by weight, of a mixture of silicon carbide and silicon nitride, preferably, the weight ratio of the quantity of silicon carbide to the quantity of silicon nitride being greater than 1, preferably greater than 2 and less than 10, preferably less than 8, preferably less than 6.

Preferably, the container comprises more than 90%, preferably more than 95%, in total, as a weight percentage based on the weight of the crystalline phases:
of corundum, MgAl₂O₄ spinel, cordierite, mullite, zirconia, optionally stabilized, periclase, and mixtures thereof, preferably corundum, MgAl₂O₄ spinel, cordierite, mullite, zirconia, optionally stabilized, and mixtures thereof, preferably corundum, spinel, cordierite and mixtures thereof, or
silicon carbide, silicon nitride, and mixtures thereof.

The container may have any shape.

The perimeter of said container according to the invention can be chosen from a polygon, in particular a rectangle and a square, a circle or an ellipse.

Preferably, the container according to the invention comprises a bottom and at least one side, preferably having an average thickness of preferably less than 20 mm, preferably less than 15 mm, or even less than 10 mm, either/or preferably greater than 2 mm, preferably greater than 4 mm, preferably greater than 5 mm.

In one embodiment, the bottom of said container has a thickness greater than that of its side, preferably 10% greater, preferably 20% greater, preferably 30% greater.

In one embodiment, the bottom and the side of said container have a difference in thickness of less than 10%, preferably less than 5%. Preferably, in said embodiment, the bottom of said container has a thickness substantially identical to that of its side.

In one embodiment, the thickness of the walls is not constant. Preferably, the thickness of the sides is greater on the bottom side of the container. Preferably, the part of the sides being in contact with the bottom of the container has a thickness greater than 10% at the thickness of the part of the sides located opposite the bottom of the container.

In one embodiment, the container has a length, that is, a longest length less than 500 mm, preferably less than 400 mm, either/or preferably greater than 100 mm, preferably greater than 200 mm, and a width, that is, the smallest dimension measured perpendicular to the length of less than 500 mm, preferably less than 400 mm, either/or preferably greater than 100 mm, preferably greater than 200 mm.

In one embodiment, the angle between the bottom of the container and said at least one side is equal to 90°. In one embodiment, said angle is greater than 90° and less than 100°.

In one embodiment, the container has a diameter of less than 500 mm, preferably less than 400 mm, either/or preferably greater than 100 mm, preferably greater than 200 mm.

Preferably, the container has a volume greater than 0.1 liters, preferably greater than 1 liter, preferably greater than 2 liters, preferably greater than 3 liters and/or preferably less than 25 liters, preferably less than 20 liters, preferably less than 15 liters.

In a preferred embodiment, the bottom and the sides of the container form a monolithic assembly. In other words, said bottom and sides are one and the same part, the connection between the bottom and the sides comprising a radius, preferably greater than 5 mm, preferably greater than 10 mm, preferably greater than 20 mm.

In one embodiment, the container is an assembly of different parts, for example plates, the connection between said various parts being notably able to be made by means of mortise and tenon assembly, and/or suspended assembly, and/or embedded type assembly (in particular using notches or grooves), and/or ceramic pins, and/or ceramic screws and/or ceramic rivets, and/or ceramic cotter pins.

### Coating

The coating has the following crystalline phases, as a percentage by weight based on the crystalline phases:
MgAl₂O₄ spinel: more than 25% and up to 60%, and
Crystalline phases other than MgAl₂O₄ spinel and corundum: <10%
Corundum: supplemented to 100%.

The crystalline phases present in the coating may conventionally be identified by X-ray diffraction on said coating.

The acquisition of the diffraction diagram is carried out with a D8 Endeavor type apparatus from Bruker, over an angular range 26 of between 5° and 80°, with a step of 0.01°, and a counting time of 0.34 s/step. The front optic has a primary slit of 0.3° and a 2.5° Soller slit. The sample rotates on its own axis at a speed equal to 5 rpm, using the automatic cutter. The rear optic has a 2.5° Soller slit, a 0.0125 mm nickel foil and a 1 D detector with an opening equal to 40.

The diffraction diagrams are then analyzed qualitatively using the EVA software and the ICDD2016 database.

Once the phases present have been identified, the diffraction patterns are analyzed quantitatively using the HighScore Plus software with Rietveld refinement according to the following strategy:
Refinement of the background signal is carried out using the “treatment”, “determine background” function with the following options selected: “bending factor” equal to 1 and “granularity” equal to 40;
Conventionally, the ICDD files for the present phases identified and quantifiable are selected, and therefore taken into account in the refinement;
Automatic refinement is then carried out by selecting the previously determined background signal (“use available background”) and by selecting the “automatic, option phase fit-default Rietveld” mode;
Manual refinement of the “B overall” parameter is then carried out simultaneously for all the selected phases.

The inventors have demonstrated that such a coating makes it possible to increase the service life of the container when manufacturing an oxide powder comprising lithium, in particular an oxide of a metal or of several lithiated transition metals.

The inventors also demonstrated that a coating having an MgAl₂O₄ spinel content greater than 60% exhibited cracking and/or detachment of the surface of the container when the temperature was increased to the operating temperature, which does not allow the container having such a coating to have an improved service life.

A coated container comprising a coating having an MgAl₂O₄ spinel content less than 10% does not have an improved service life.

The coating preferably has an MgAl₂O₄ spinel content greater than 30%, preferably greater than 35%, and preferably less than 55%, preferably less than 50%, as a weight percentage based on the crystalline phases.

Preferably, the coating has a crystalline phase content other than MgAl₂O₄ spinel and corundum of less than 8%, preferably less than 5%, as a weight percentage based on the crystalline phases. Preferably, the coating has a crystalline phase content other than MgAl₂O₄ spinel and substantially zero corundum.

Preferably, the coating has a quantity of amorphous phases of less than 10%, preferably less than 5%, preferably substantially zero.

Preferably, the coating has the following chemical composition, as an oxide weight percentage:
MgO: >2.8%, preferably >4%, preferably >5.5%, preferably >7%, preferably >8.5%, and preferably <16.9%, preferably <15.5%, preferably <14%, and/or
Al₂O₃: >73.1%, preferably >75%, preferably >78%, preferably >80%, preferably >83%, and preferably <97%, preferably <95%, preferably <92%, preferably <90%, and/or
Oxides other than MgO and Al₂O₃: <10%, preferably <8%, preferably <6%, preferably <5%, preferably <3%, preferably <1%, preferably <0.5%.

The coating consists of more than 90%, preferably more than 95%, preferably more than 98%, preferably more than 99%, preferably more than 99.5% by weight of oxides. Preferably, the coating consists essentially of oxides.

The thickness of said coating is preferably greater than 50 μm, preferably greater than 100 μm, preferably greater than 200 μm, preferably greater than 300 μm, or even greater than 400 μm, or even greater than 500 μm, or even greater than 600 μm and/or preferably less than 2000 μm, preferably less than 1500 μm, preferably less than 1000 μm, preferably less than 800 μm.

Preferably, the surface of the covered inner walls comprises the bottom of the container and the part of the sides in contact with said bottom. In other words, the coating extends over the lower inner part of the sides of the container, the container being considered in its operating position, said part being that in contact with the powders during the use of said container.

Preferably, the surface of the inner walls of the container is covered by more than 85%, preferably more than 90%, preferably more than 95%, preferably more than 96%, preferably more than 98%, preferably more than 99% with said coating. Preferably, the coating extends substantially over the entire surface of the inner walls of the container.

Preferably, at least a part, preferably the entire surface of the outer wall of the bottom is covered with the coating.

In one embodiment, more than 90%, preferably more than 95%, preferably more than 99%, of the total surface area of the walls of the container is covered with the coating.

The coating can be applied to at least part of the surface of the inner walls of the container according to any technique known to a person skilled in the art, in particular by application using a brush, by spraying, in particular a wet spray, by vacuum impregnation, by immersion. Preferably, the coating is applied by wet spraying a suspension comprising one or more MgAl₂O₄ powders and one or more corundum or corundum precursor powders. Preferably, the suspension does not comprise corundum precursor powders.

Preferably, the coating has undergone heat treatment before its use, the maximum temperature reached during said heat treatment preferably being greater than 1100° C., preferably greater than 1200° C., and preferably less than 1500° C., preferably less than 1400° C.

The holding time at said maximum temperature is preferably greater than 0.5 hours, and less than 5 hours, preferably less than 2 hours.

### Examples

The following non-limiting examples are given with the aim of illustrating the invention.

### Manufacturing Protocol for Examples

To manufacture the examples, tiles with dimensions of 50×50×10 mm³ are machined on the 6 faces on N-Durance plates sold by Saint-Gobain Performance Ceramics and Refractories.

A large surface of each tile is then coated by wet spraying a suspension.

Suspensions making it possible to obtain the various coatings are manufactured in the following way.

A mixture M of alumina powders with a mass purity greater than 99% and an aluminum hydroxide powder is achieved. Said mixture M has a median size D₅₀ equal to 7 μm and a D₉₀ equal to 51 μm.

Mixtures are then made, in accordance with Table 1 below, as a weight percentage.

TABLE 1

| | Mixture | Mixture | Mixture | Mixture |
|---|---|---|---|---|
| | for the | for the | for the | for the |
| | example 1 | example 2 | example 3 | example 4 |
| | coating | coating | coating | coating |
| Mixture M | 100 | 85 | 70 | 55 |
| AR78 spinel | 0 | 15 | 30 | 45 |
| powder, −90 μm | | | | |
| sold by Almatis | | | | |

Then, 0.3% of sodium silicate and 0.5% of a stabilizing solution are added to each mixture to prevent any segregation in the coating when it is applied to the tiles, and alumina beads, the percentages of sodium silicate and said stabilizing suspension being weight percentages based on the total weight of the mixture M and the spinel powder.

The solution is placed in a can and rotated using a rotating jar for 10 minutes in order to mix the various ingredients.

Then, 40% water and 2.5% of a dispersion adhesive are added to the can, particularly in order to achieve a sufficient abrasion resistance of the coating, the percentages being weight percentages based on the total weight of the mixture M and the spinel powder.

The can is closed and is then rotated using a rotating jar for 8 hours so as to obtain a homogeneous suspension.

The beads are then separated from the suspension by sieving.

The suspension is then placed in a compressed air gun and sprayed onto a large surface of a tile, so as to obtain a coating of substantially uniform thickness equal to 300 μm after the consolidation step by sintering.

Then the coated tile is dried in an oven for 12 hours at 70° C.

Finally, the coated tile undergoes the following consolidation heat treatment, in an electric furnace in air:
Increase at 1450° C. at a rate equal to 300° C./h,
Maintained at 1450° C. for 1 hour,
Decrease to 500° C. at a rate equal to 300° C./h, then uncontrolled decrease.

The coated tiles thus obtained then undergo the degradation resistance test described below:

The degradation resistance of a lithium-nickel-manganese-cobalt (Li-NMC) oxide powder is assessed on the coated tiles described above according to examples 1 to 4, the surface of the tile in contact with the powder being the surface having the coating previously described.

The powder of a lithium-nickel-manganese-cobalt oxide used is manufactured in the following way:

An Ni_{0.8}Co_{0.1}Mn_{0.1}(OH)₂ powder is obtained by coprecipitation of an aqueous solution of nickel nitrate, cobalt nitrate and manganese nitrate, found at a stoichiometric ratio of 0.8:0.1:0.1, by adding NaOH and NH₄OH, at a temperature equal to 50° C. with stirring.

After drying the precipitate, LiOH·H₂O is added to the Ni_{0.8}Co_{0.1}Mn_{0.1}(OH)₂ powder in a molar ratio of LiOH·H₂O on Ni_{0.8}Co_{0.1}Mn_{0.1}(OH)₂ equal to 1.03, the mixture then being mixed vigorously.

Then, the mixture is then heat treated at 480° C. for 4 hours.

The powder obtained after heat treatment is crushed in an agate mortar. The powder obtained from crushing is the powder used in the degradation resistance test.

For each example, 4.5 g of said powder is placed on the central part of the tile being tested, taking care not to cover the surface of the periphery of said tile with powder.

The tiles are then placed in an electric tube furnace, the tube being made of alumina, to undergo the following heat treatment cycle:
Increase up to 800° C. at a rate equal to 200° C./h
Maintained at the temperature of 800° C. for 10 hours
Decrease to 500° C. at a rate equal to 200° C./h, then uncontrolled decrease to room temperature.

During the entire heat treatment process, oxygen is circulated in the tube at a flow rate equal to 20 L/min.

The tiles are then taken out of the furnace. The powder present on the top of the tile is removed, and 4.5 g of new powder is again placed on the central part of the tile being tested, taking care not to cover the surface of the periphery of said tile with powder. The tiles are then placed in an electric tube furnace, the tube being made of alumina, to undergo a second heat treatment cycle identical to the first.

The tiles are then taken out of the furnace. The powder present on the top of the tile is removed. The same protocol as previously described is repeated again three times so that each tile undergoes five heat treatment cycles in total, in the presence of the powder described above.

The tiles are then taken out of the furnace and each tile is cut so as to obtain a section of the central zone of said tile. Said section is coated with a resin and mirror polished.

Then each polished sample is observed using a scanning electric microscope, using magnifications comprised between ×200 and ×500.

Table 2 below summarizes the results obtained.

TABLE 2

| | Amount of | |
|---|---|---|
| | spinel in the | |
| | coating, as a | Visual condition of |
| | weight | the coating after the |
| Examples | percentage | degradation resistance test |
| 1 | 0 | The coating has almost completely |
| | | disappeared |
| 2 | 15 | Multiple cracks present on the outer |
| | | surface of the coating up to the interface |
| | | between the coating and the tile surface |
| 3 | 30 | A few cracks present on the outer surface |
| | | of the coating and not extending to the |
| | | interface between the coating and tile |
| | | surface |
| 4 | 45 | No cracks |

A comparison of examples 1, and 2 to 4 shows that the coating of examples 2 to 4 is still present after the degradation resistance test, unlike the coating of example 1 which has almost completely disappeared.

However, a comparison of examples 2 to 4 shows that the coating of example 2, which has an amount of spinel equal to 15%, comprises several cracks, present on the outer surface of the coating up to the interface between the coating and tile surface.

After the degradation resistance test, the coating of example 3, having an amount of spinel equal to 30%, has some cracks present on the outer surface of the coating and not extending to the interface between the coating and tile surface

The coating of example 4 having an amount of spinel equal to 45%, has the best resistance; no cracks being visible after the degradation resistance test.

These results show the effectiveness of a container according to the invention.

Of course, the invention is not limited to the embodiments described, which are provided as illustrative and non-limiting examples.

In particular, the products according to the invention are not limited to particular shapes or dimensions.

1. A container for manufacturing an oxide powder comprising lithium, a surface of inner walls thereof is at least partially covered, with a coating having the following crystalline phases, as a percentage and based on the total weight of the crystalline phases:
MgAl₂O₄ spinel: more than 25% and up to 60%, and
crystalline phases other than MgAl₂O₄ spinel and corundum: <10%
corundum: supplemented to 100%.

2. The container according to claim 1:
wherein the coating has, as a weight percentage based on the crystalline phases, a spinel content greater than 30% and/or less than 55%, and/or
comprising more than 90%, by weight, of oxide(s), carbide(s), nitride(s), oxynitride(s), boride(s), and mixtures thereof, and/or
wherein a thickness of said coating is greater than 50 μm and less than 2000 μm, and/or
wherein the surface of the inner walls covered by said coating comprises a bottom of said container and a part of the sides being in contact with said bottom, and/or
the surface of the inner walls thereof is covered by more than 85% with said coating.

3. The container according to claim 1:
wherein the coating has, as a weight percentage based on the crystalline phases, a spinel content greater than 35% and/or less than 50%, and/or
comprising more than 95%, by weight, of oxide(s), carbide(s), nitride(s), oxynitride(s), boride(s), and mixtures thereof, and/or
wherein a thickness of said coating is greater than 100 μm and less than 1500 μm, and/or
the surface of the inner walls thereof is covered by more than 90% with said coating.

4. The container according to claim 1:
comprising more than 99%, by weight, of oxide(s), carbide(s), nitride(s), oxynitride(s), boride(s), and mixtures thereof, and/or
wherein a thickness of said coating is greater than 200 μm and less than 1000 μm, and/or
the surface of the inner walls thereof is covered by more than 95% with said coating.

5. The container according to claim 1
wherein a thickness of said coating is greater than 300 μm and less than 800 μm, and/or
the coating thereof extends substantially over the entire surface of the inner walls of said container.

6. The container according to claim 1, comprising more than 90% by weight of oxide(s).

7. The container according to claim 6, comprising Al₂O₃, MgO, ZrO₂, SiO₂, Y₂O₃, and mixtures thereof.

8. The container according to claim 1, having an Al₂O₃+MgO+ZrO₂+SiO₂+Y₂O₃ content greater than 90% as an oxide weight percentage.

9. The container according to claim 1, having
an Al₂O₃ content greater than 90% g 95%, as an oxide weight percentage, or
an SiO₂ content greater than 90%, preferably greater than 95%, as an oxide weight percentage, or
an Al₂O₃+MgO content greater than 90% as an oxide weight percentage, or
an Al₂O₃+Y₂O₃ content greater than 90% as an oxide weight percentage, or
an Al₂O₃+MgO+SiO₂ content greater than 90% as an oxide weight percentage, or
an Al₂O₃+ZrO₂+SiO₂ content greater than 90% as an oxide weight percentage, or
an Al₂O₃+ZrO₂ content greater than 90%, as an oxide weight percentage, or
an Al₂O₃+SiO₂ content greater than 90%, as an oxide weight percentage.

10. The container according to claim 1, comprising more than 90% in total and as a percentage based on the total weight of the crystalline phases, of corundum, MgAl₂O₄ spinel, cordierite, mullite, zirconia, optionally stabilized, periclase, and mixtures thereof.

11. The container according to claim 10, comprising more than 90% in total and as a percentage based on the total weight of the crystalline phases, of corundum or mullite or a mixture of corundum and cordierite or a mixture of corundum and mullite or a mixture of corundum and MgAl₂O₄ spinel or a mixture of corundum and cordierite and spinel, or a mixture of corundum and zirconia or a mixture of corundum and mullite and zirconia or a mixture of cordierite and mullite.

12. The container according to claim 1, comprising more than 90% by weight of carbide(s), nitride(s), oxynitride(s), borides and mixtures thereof.

13. The container according to claim 12, comprising more than 90% by weight in total, of carbide(s), nitride(s), SiAlON and mixtures thereof.

14. The container according to claim 13, comprising more than 90% by weight and in total, of silicon carbide, silicon nitride, SiAlON, and mixtures thereof.

15. The container according to claim 14, comprising more than 90% by weight of a mixture of silicon carbide and silicon nitride.

16. The container according to claim 1,
having a perimeter chosen from a polygon, a circle or an ellipse, and/or
comprising a bottom and at least one side, and/or
has a volume greater than 0.1 liters and less than 25 liters.

17. The container according to claim 1, for manufacturing an oxide powder of a metal or of several lithiated transition metals.

18. The container according to claim 1, wherein more than 80% of the surface of the inner walls of said container are covered with the coating.

19. The container according to claim 6, comprising more than 95% by weight of oxide(s).

20. The container according to claim 8, having an Al₂O₃+MgO+ZrO₂+SiO₂+Y₂O₃ content greater than 95% as an oxide weight percentage.
